(19) United States
(12) Patent Application Publication
(10) Pub. No.: US 2007/0220085 A1
(43) Pub. Date: Sep. 20, 2007

(54) Control channel discovery protocol

(76) Inventors: Thomas W. Hambleton, Plano, TX (US); Michael Soulakis, Frisco, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(21) Appl. No.: 11/378,142

(22) Filed: Mar. 17, 2006

(51) Int. Cl. G06F 15/16

(52) U.S. Cl. 709/203

(57) ABSTRACT

In a telecommunications/data network (10), IP control channels between out-of-band control plane entities are automatically created through discovery of information by state machines implementing an ICDP (IP Control channel Discovery Protocol). Control plane entities executing the protocol send address information in BootStrapMessages and optional GatewayMessages through their local network element to a far-end network element and wait for similar messages from the far-end network elements. When the information is received, control channels are created, if they do not already exist.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to telecommunication and data networks and, more particularly, to distributed control planes for telecommunication and data networks.

2. Description of the Related Art

Intelligent networks are being developed with routers, switches, cross-connects, DWDM (Dense Wavelength Division Multiplexing) systems, ADMs (Add-Drop Multiplexers), and other devices, that use a common distributed control plane to dynamically provision network resources and to provide advanced network protection and restoration capabilities. One of the fundamental concepts associated with distributed control plane enabled networks is the ability to automate the process of configuring and managing the infrastructure of the data network structure.

In order to perform its function, a control plane entity must communicate with other control plane entities over established control channels. A “control channel” is a pair of mutually reachable communication interfaces (such as IP interfaces) that are used to enable communication between nodes for distributed control plane protocol messages. If the control plane entities were imbedded within the network elements of the data network, then information passed on the data transport links could be used to automatically establish the proper IP control channels between the control plane entities. However, with an out-of-band control plane, i.e., where control plane entities do not have direct access to a control channel on a data transport link, there is no mechanism for establishing the control channels between control plane entities associated with adjacent network elements. Accordingly, in an out-of-band distributed control plane, each control plane entity must be manually configured to establish the control channels between peers.

When a control plane entity is created, the user performs the following steps to enable a network element and a transport plane resource on that network element to be visible and managed by the newly created control plane entity:
1) Configure Node Entity (associate a particular network element with the newly created control plane entity by assigning a SCN/DCN address and Node Id);
2) Manually define control plane peers (determine, manually, which nodes are physically connected in the transport network to the associated network element and manually provision this information into the Node Entity data base);
3) Manually define control channels between peers (for each control plane peer, the user must go to both far-end and near-end nodes and manually setup IP interfaces, by running ifconfig or similar software, and assign IP address, masks and routes); and
4) Create link entity (User specifies transport plane resource he would like to put under control plane surveillance, for example a specific OC48 link).

Manual configuration is costly, time consuming and error prone. Furthermore, any change to the configuration of the transport network will require reconfiguration of the control channels between control plane entities.

Therefore, a need exists for automatic provisioning of control channels between control plane entities.

### BRIEF SUMMARY OF THE INVENTION

In the present invention, control channels are automatically defined and created between distributed out-of-band control plane entities in a network, where each control plane entity is associated with a network element having a transport link. At a local control plane entity, a bootstrap message including a node ID and a reachable address for the local control plane entity is generated and sent through the associated network element to an other network element over a transport link. Upon receiving a bootstrap message at the associated network element from the other network element, a control channel is automatically created between the local control plane entity and a control plane entity associated with the other network element.

The present invention provides significant advantages over the prior art. An operator can set up an IP control channel between out-of-band control plane entities simply by selecting the two entities and initiating the discovery. Alternatively, the discovery could take place in batch mode without operator intervention. Manual entry is greatly reduced, since the user need only configure the node entity by associating a particular network element with the control plane entity and create a link entity. The steps of manually defining control plane peers and manually defining control channels are eliminated.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a telecommunications/data network with an out-of-band distributed control plane;

FIG. 2 illustrates a state diagram which controls execution of a protocol of automatic discovery of control channel information;

FIG. 3 illustrates a state diagram describing operation of the Init state of FIG. 2;

FIG. 4 illustrates a format for bootstrap and control messages used in the protocol implemented in FIG. 2.

### DETAILED DESCRIPTION OF THE INVENTION

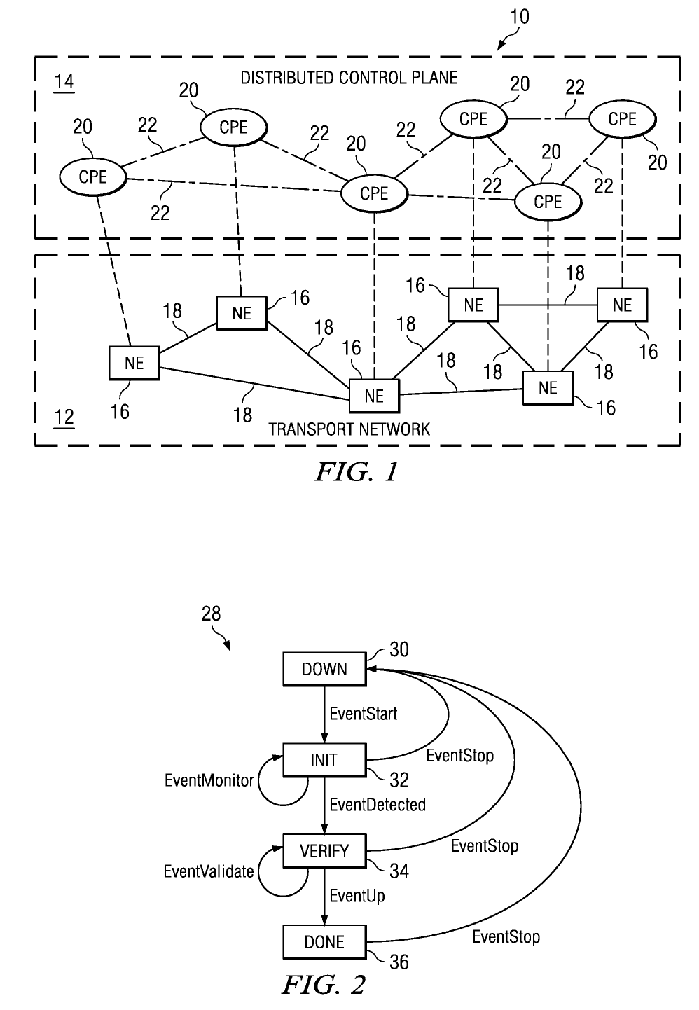

The present invention is best understood in relation to FIGS. 1-4 of the drawings, like numerals being used for like elements of the various drawings.

FIG. 1 illustrates an example of a network 10 with a data transport network 12 and an out-of-band distributed control plane 14. The transport plane 12 includes a plurality of network elements (for example, routers, switches, and cross-connects) 16 coupled by transport links 18, typically optical fibers. The distributed control plane 14 includes a plurality of control plane entities 20, each control plane entity being associated with a respective one of the network elements 16. The control plane entities 20 could be a dedicated hardware device or an instance of a process executing on a computer. Multiple control plane entities 20 could be simultaneously executing on a single computer. Control plane entities 20 do not need to be physically located near the network element 16 that they control.

The network elements 16 communicate with one another over the physically linked data transport network 12, while the control plane entities 20 communicate with one another, and with the network elements 16, over DCN (Data Communication Network), typically an IP (internet protocol) based network. Each control plane entity 20 can communicate with its respective network element 16 over the DCN using well-established protocols.

The main purpose of the control plane 14 is end-to-end provisioning, where an engine 20 can calculate a path between any two network elements 16 in the network 12, and send the commands to the network elements 16 to set up the service. To perform this function, the engines 20 need to establish control channels 22 between adjacent peers in the control plane 12.

FIG. 2 illustrates a state diagram showing the operation of a finite state machine 28 implementing the ICDP (IP Control channel Discovery Protocol) within a control plane entity 20. The ICDP controls automatic discovery of control channel information necessary to establish control channels between peers in an out-of-band distributed control plane.

For purposes of explanation of the operation of the ICDP, the discovery process between two control plane entities will be described as occurring between a “near-end” or “local” control plane entity (associated with a near-end or local network element 16) and a “far-end” control plane entity (associated with a far-end network element 16). The designations “near-end”, “local” and “far-end” are relative to a control plane entity 20; each control plane entity sees itself as the “near-end” or “local” control plane entity (and its associated network element as the “near-end” or “local” network element) and sees the other control plane entity and network element as “far-end” devices.

Initially, the state machine 28 of a control plane entity 20 is in a “down” state 30. The state machine remains in the down state 30 until an EventStart signal is received. The EventStart signal is initiated by an external agent action; for example, by an operator using a graphical user interface (GUI) to initiate the discovery between two control plane entities, or through an automated process that selects control plane entities 20 for discovery. Once the EventStart signal is received, the state machine transitions to the Init state 32.

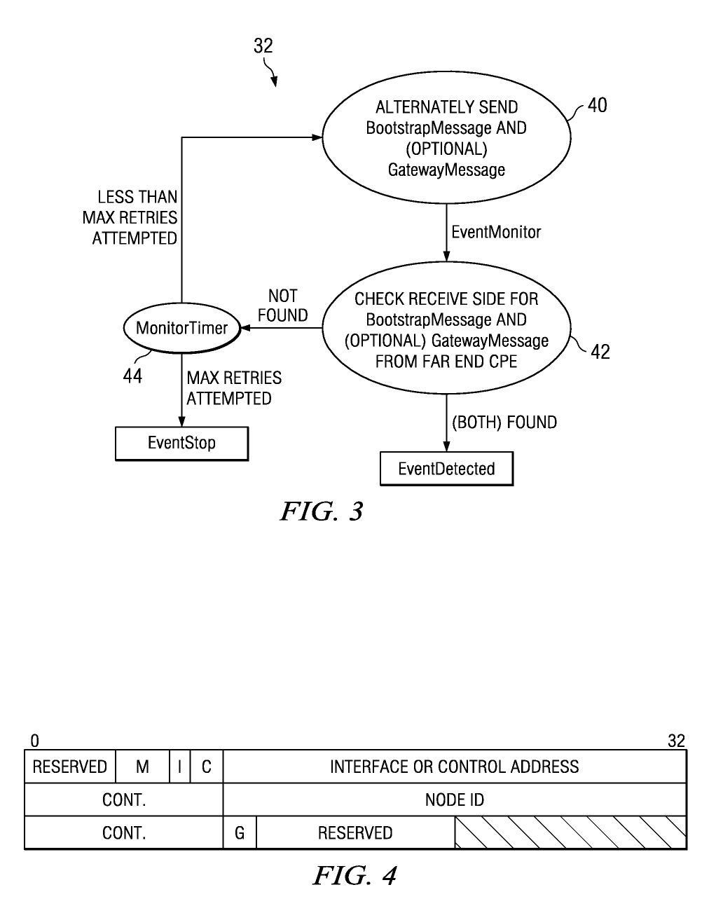

The Init state 32 is described in greater detail in connection with FIG. 3. In state 40, a bootstrap message (BootStrapMessage) is sent via the local network element (for example, within a SONET section trace message). An optional gateway message (GatewayMessage), if needed, may be sent alternately with the BootStrapMessage. An example of a format for sending these messages is shown below in connection with FIG. 4. The BootStrapMessage is used by the near-end control plane entity to communicate its Node ID and DCN IP Address to a far-end control plane entity. The Node ID is a value used to uniquely identify the distributed control plane entity in the network. This could be, for example, an IPv4 formatted value. The Node ID may or may not be a reachable IP address and is usually the same value as the Router ID used in IGP (Interior Gateway Protocol) routing protocols (e.g. IETF OSPF). The DCN IP Address is a unique reachable address (such as an IPv4 address) associated with an interface connected to the provider's DCN. This address is used by the far-end control plane entity to instantiate an end point of a control channel. The GatewayMessage is an optional message used to communicate the gateway DCN IP address associated to the local DCN IP address specified in the BootStrapMessage. The gateway DCN IP address is a unique reachable address (such as an IPv4 address) associated to a DCN entity that is responsible for providing IP reachability to the other subnetworks within the customers DCN (such as a router). If needed, a bit will be set in the associated Bootstrap message indicating that a GatewayMessage will also be sent in alternate trace messages.

In state 40, the near-end control plane entity 20 encodes an BootStrapMessage with local Node ID and local DCN IP address (or, on alternate cycles, a GatewayMessage, if necessary) and passes the message to its associated network element 16 (the “local” network element) for transmission to the far-end network element 16. Once the message is passed to the local network element 16, an EventMonitor event is generated.

In state 42, the control plane entity 20 checks the receive side of its local interface for a message (i.e., a BootStrapMessage and GatewayMessage, if indicated) from the far-end control plane entity 20. If no message is detected, to control the polling cycle for detecting the in-band protocol messages at the local network element. The monitor interval is controlled via a user provided MonitorIntervalValue. The MonitorIntervalValue determines the time interval between polling cycles. A second user provided value, MonitorIntervalMaxRetryValue, determines how many times the MonitorTimer shall run before it is deemed necessary to abort the Monitoring process.

If the BootStrapMessage and GatewayMessage, if indicated, are not received within the maximum number of retries, then the an EventStop event is generated, which triggers the local network element to stop transmitting message(s). The state machine then transitions back to a Down state 30.

If, on the other hand, a far-end BootStrapMessage and GatewayMessage, if indicated, are detected by a control plane entity at the receive side of its local interface, then the state machine 28 generates an EventDetected event. Returning to FIG. 2, the EventDetected event causes a transition to a Verify state 34. In the Verify state 34, the control plane entity 20 determines whether an existing IP control channel already exists to the detected far-end control plane entity and the near-end control plane entity. If an IP control channel does exist to the detected far-end control plane entity, then an EventUp event is generated and the state machine 28 transitions to the Done state 36. Once in the Done state 36, the automatic IP control channel discovery and creation are complete between the two control plane entities. From this state, a EventStart could be generated by the operator to restart the process.

On the other hand, if an IP control channel does not exist to the detected far-end control plane entity in the verify state 34, the state machine 28 sends a message to the appropriate subsystem to create the IP control channel. The VerifyTimer is then set and the state machine remains in the Verify state. The VerifyTimer is used to control the polling cycle for checking if an IP control channel has been successfully created. The verify interval in controlled via a user provided VerifyIntervalValue. The VerifyIntervalValue determines the time interval between verify polling cycles. A second user provided value, VerifyIntervalMaxRetryValue, determines how many times the VerifyTimer shall run before it is deemed necessary to abort the Verify process.

Upon the VerifyTimer expiring, the Verify state will check to see if the IP control channel was successfully created via external interface provided by subsystem responsible from IP control channel creation. If the IP control channel is still not present, and the maximum number of VerifyTimers have expired, the control plane entity will generate a EventStop event and transition back to the Down state 30. If the IP control channel was successfully created, the EventUp event is generated and the state machine 28 transitions to the Done state 36.

FIG. 4 illustrates a format for the BootStrapMessage and GatewayMessage. A two-bit Message ID field (M) specifies the type of message being sent: 00—Trace message, 01—BootStrapMessage, 02—GatewayMessage for previous BootStrapMessage, or 04—Reserved for future use. A one-bit Interface Address Type field (I) specifies the interface address type: 0—Ipv4 or 1—unnumbered. A one-bit Control Address Type field specifies the control address type: 0—Ipv4 or 1—unnumbered. The value of the 32-bit Interface or Control Address field depends upon the message type. If Message Type=BootStrapMessage, then this field stores the DCN IP Address of the local control plane entity interface. If Message Type=GatewayMessage, then this field stores the gateway DCN IP address that should be used by the far-end control channel entity to reach the DCN IP specified in the previous BootStrapMessage.

The 32-bit Node ID field stores the (IPv4 formatted) Node ID used to uniquely identify the local control plane entity. The Node ID may or may not be routable.

The one-bit Gateway Flag field indicates whether an associated GatewayMessage will be sent. If Message Type=BootStrapMessage and the Gateway Flag field is set, then indicates a GatewayMessage will follow upon successfully receiving a far-end BootStrapMessage.

A SONET section trace requires a specific character set to be used to specify a 15 character printable ASCII string. Base64 encoding is used to convert the 80 bits of ICDP protocol message data into a valid 15 character ASCII string.

The present invention provides significant advantages over the prior art. An operator can set up an IP control channel between out-of-band control plane entities simply by selecting the two entities and initiating the discovery. Alternatively, the discovery could take place in batch mode without operator intervention. Manual entry is greatly reduced, since the user need only configure the node entity by associating a particular network element with the control plane entity and create a link entity. The steps of manually defining control plane peers and manually defining control channels are eliminated.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A method of automatically defining and creating control channels between distributed out-of-band control plane entities in a network, where each control plane entity is associated with a network element having a transport link, comprising the steps of:
generating, at a local control plane entity, a bootstrap message including a node ID and a reachable address for the local control plane entity;
sending the bootstrap message through the associated network element to an other network element over a transport link;
upon receiving a bootstrap message at the associated network element from the other network element, creating a control channel between the local control plane entity and a far-end control plane entity associated with the other network element.

2. The method of claim 1 wherein the control channels are IP control channels.

3. The method of claim 1 wherein the creating step comprises the step of creating a control channel between the local control plane entity and a control plane entity associated with the other network element only if such a control channel does not already exist.

4. The method of claim 1 wherein the bootstrap message is sent in a SONET section trace.

5. The method of claim 1 wherein the bootstrap message is encoded.

6. The method of claim 1 and further comprising the step of sending a gateway message including a reachable address for a gateway device.

7. The method of claim 6 wherein the bootstrap message indicates whether a gateway message will be sent.

8. The method of claim 7 wherein said creating step comprises the step of creating a control channel between the local control plane and the far-end control plane only after receiving the gateway message, if the received bootstrap message indicates that a gateway message will be sent.

9. Circuitry for automatically defining and creating control channels between distributed out-of-band control plane entities in a network, where each control plane entity is associated with a network element having a transport link, comprising:
control circuitry for:
generating, at a local control plane entity, a bootstrap message including a node ID and a reachable address for the local control plane entity;
sending the bootstrap message through the associated network element to an other network element over a transport link;
upon receiving a bootstrap message at the associated network element from the other network element, creating a control channel between the local control plane entity and a far-end control plane entity associated with the other network element.

10. The circuitry of claim 9 wherein the control channels are IP control channels.

11. The circuitry of claim 9 wherein the control circuitry creates a control channel only if such a control channel does not already exist.

12. The circuitry of claim 9 wherein the bootstrap message is sent in a SONET section trace.

13. The circuitry of claim 9 wherein the bootstrap message is encoded.

14. The circuitry of claim 9 wherein said control circuitry further sends a gateway message including a reachable address for a gateway device.

15. The circuitry of claim 14 wherein the bootstrap message indicates whether a gateway message will be sent.

16. The circuitry of claim 15 wherein said creating the control channel is created between the local control plane and the far-end control plane only after receiving the gateway message, if the received bootstrap message indicates that a gateway message will be sent.
